(19) United States
(12) Patent Application Publication
(10) Pub. No.: US 2007/0133686 A1
(43) Pub. Date: Jun. 14, 2007

(54) Apparatus and method for frame interpolation based on motion estimation

(75) Inventors: Ho-young Lee, Yongin-si (KR); Hyun-hwa Oh, Yongin-si (KR); Chang-yeong Kim, Yongin-si (KR); Du-sik Park, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/637,803

(22) Filed: Dec. 13, 2006

(30) Foreign Application Priority Data
Dec. 14, 2005 (KR) 10-2005-0123512

(51) Int. Cl. H04N 11/02; H04B 1/66

(52) U.S. Cl. 375/240.16; 375/240.27

(57) ABSTRACT

A method for frame interpolation based on motion estimation converts a frame rate of an image frame source according to an appliance that displays the image frame. An apparatus for frame interpolation based on motion estimation includes a motion vector estimation unit estimating a final motion vector of a block in a specified frame, a motion vector post-processing unit smoothing the estimated final motion vector, and a motion error concealment unit concealing an error due to discontinuity among blocks having the smoothed final motion vector.

### CROSS-REFERENCE TO RELATED APPLICATION

This application is based on and claims priority from Korean Patent Application No. 10-2005-00123512, filed on Dec. 14, 2005 in the Korean Intellectual Property Office, the disclosure of which is incorporated herein in its entirety by reference.

### BACKGROUND OF THE INVENTION

1. Field of the Invention

The present invention relates to an apparatus and method for frame interpolation based on motion estimation and, more particularly, to an apparatus and method for frame interpolation based on motion estimation that can convert a frame rate of an image frame source according to an appliance that displays the image frame.

2. Description of the Prior Art

Generally, television systems are classified into NTSC (National Television System Committee) systems, PAL (Phase Alternation by Line) systems, and SECAM (System Electronique Avec Memoire) systems. The NTSC system is adopted in America, Korea, Japan, and Canada, the PAL system is adopted in Europe, China, and North Korea, and the SECAM system is adopted in France and Russia.

In the NTSC system, the number of scanning lines is 525, and field frequency is 60 fields per second. In the PAL or SECAM systems, the number of scanning lines is 625, and field frequency is 50 fields per second. This field frequency can be understood as the number of frames per second (hereinafter referred to as “frame rate”). In other words, the television systems output image frame sources in accordance with their corresponding frame rates, respectively.

The television systems as described above use different frame rates. If an image frame source, which can be normally outputted through a PAL television system, is outputted through an NTSC system having a higher frame rate than the PAL television system, the number of frames being outputted per second is decreased, and thus picture-quality deterioration occurs. Accordingly, in order to overcome the picture-quality deterioration due to the different number of frames being outputted per second, a method of repeatedly outputting a specified frame has been used. On the other hand, in the case of outputting a film source having 24 or 25 frames per second through the television systems, the picture-quality deterioration also occurs due to the frame rates being different from the television systems.

In the case of a digital television being recently popularized, a simple repetition of a frame as described above has limitations in improving the picture quality. Accordingly, a scheme for reducing a recognizable degree of picture-quality deterioration during a frame-rate conversion has been required in a high-resolution digital television.

Korean Patent Unexamined Publication No. 2001-082934 discloses a motion estimation method and apparatus that can improve coding efficiency by selecting a motion vector in consideration of a zero vector and a predicted motion vector in addition to a motion vector having the minimum error. According to this motion estimation method and apparatus, the coding efficiency is improved by adaptively selecting a motion vector among a zero vector, a predicted motion vector, and a minimum error motion vector, in consideration of a bit length of the motion vector generated together with a motion compensation error in the process of motion estimation of a moving image encoder.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Accordingly, the present invention provides an apparatus and method for frame interpolation based on motion estimation which can prevent deterioration of picture quality from occurring when an image frame source is outputted by converting a frame rate of the image frame source according to a frame rate of an appliance that outputs the image frame.

Additional advantages and features of the invention will be set forth in part in the description which follows and in part will become apparent to those having ordinary skill in the art upon examination of the following or may be learned from practice of the exemplary embodiments of the invention.

According to one aspect of the invention, there is provided an apparatus for frame interpolation based on motion estimation which includes a motion vector estimation unit estimating a final motion vector of a block in a specified frame, a motion vector post-processing unit smoothing the estimated final motion vector, and a motion error concealment unit concealing an error due to discontinuity among blocks having the smoothed final motion vector.

In another aspect of the present invention, there is provided a method for frame interpolation based on motion estimation, which includes estimating a final motion vector of a block in a specified frame, smoothing the estimated final motion vector, and concealing an error due to discontinuity among blocks having the smoothed final motion vector.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the construction of an apparatus for frame interpolation based on motion estimation according to an exemplary embodiment of the present invention;

FIG. 2 is diagram illustrating a block of which a motion vector is to be estimated in a current frame according to an exemplary embodiment of the present invention;

FIG. 3 is a diagram illustrating a full search region and a limited search region according to an exemplary embodiment of the present invention;

FIG. 4 is a diagram illustrating a boundary surface on which a discontinuity occurs according to an exemplary embodiment of the present invention;

FIG. 5 is a diagram illustrating block groups having different motion vector directions according to an exemplary embodiment of the present invention;

FIG. 6 is a diagram illustrating the number of blocks used in a full search in the case of repeatedly using the previous frame according to an exemplary embodiment of the present invention;

FIG. 7 is a diagram illustrating the number of blocks used in a full search in the case of using motion estimation according to an exemplary embodiment of the present invention;

FIG. 8 is a flowchart illustrating a method of estimating a final motion vector according to an exemplary embodiment of the present invention;

FIG. 9 is a flowchart illustrating a method of post-processing a motion vector according to an exemplary embodiment of the present invention;

FIG. 10 is a diagram illustrating multiple representative directions according to an exemplary embodiment of the present invention; and

FIG. 11 is a flowchart illustrating a method of calculating weighted averages according to an exemplary embodiment of the present invention.

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

The present invention will be described herein with reference to the accompanying drawings illustrating block diagrams and flowcharts for explaining an apparatus and method for frame interpolation based on motion estimation according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Generally, in the case of outputting an image frame source having a different frame rate, a process of converting the frame rate of the image frame source according to the frame rate of an appliance that outputs the image frame source is performed. In other words, if the frame rate of the image frame source is higher than that of the appliance outputting the image frame source, the frame is skipped, while if not, the frame rate of the image frame source is converted to match the frame rate of the appliance outputting the image frame source by increasing the number of frames of the image frame source.

In order to increase the number of frames of the image frame source, a specified frame is repeatedly outputted, or a frame is added through motion estimation and compensation between two specified frames in the image frame source.

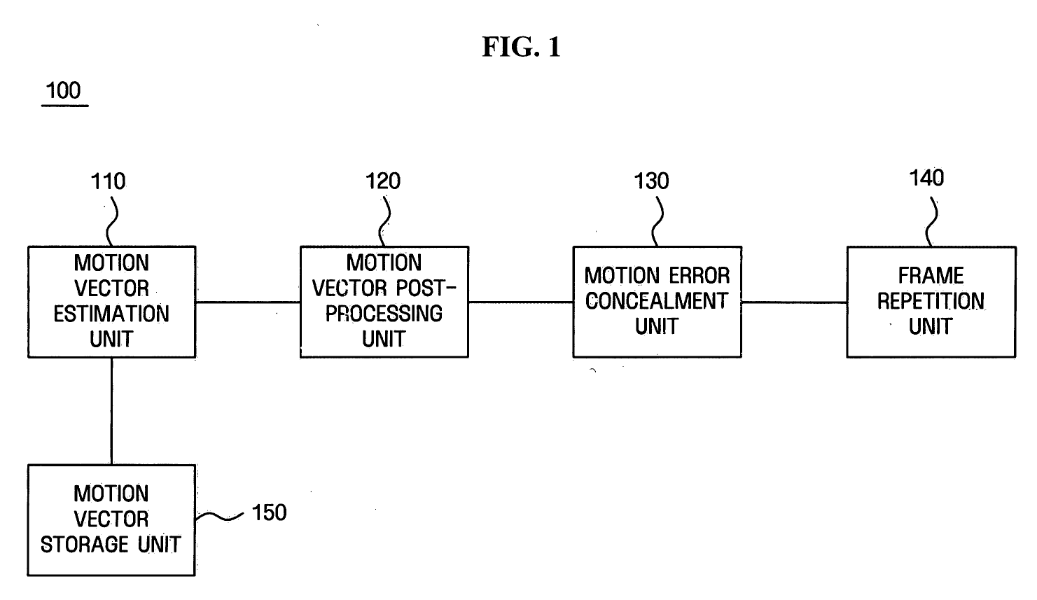

An apparatus for frame interpolation based on motion estimation according to an exemplary embodiment of the present invention, as described above, is to output an image frame source of a high picture in the case of adding a frame through motion estimation and compensation between two specified frames in the image frame source. FIG. 1 is a block diagram illustrating the construction of an apparatus for frame interpolation based on motion estimation according to an exemplary embodiment of the present invention.

As illustrated in FIG. 1, the apparatus 100 for frame interpolation based on motion estimation according to an exemplary embodiment of the present invention includes a motion vector estimation unit 110, a motion vector post-processing unit 120, a motion error concealment unit 130, a frame repetition unit 140, and a motion vector storage unit 150.

The motion vector estimation unit 110 can estimate an optimum motion vector by considering as a candidate vector a motion vector of a block of the previous frame that is in the same position as the corresponding block of the current frame on the basis of the characteristic of temporal correlation between frames. In the exemplary embodiment of the present invention, t motion vectors of the previous frame are stored in the motion vector storage unit 150. The motion vector storage unit 150 may include devices in the form of a cache, ROM, PROM, EPROM, EEPROM, SRAM, and DRAM, but is not limited thereto.

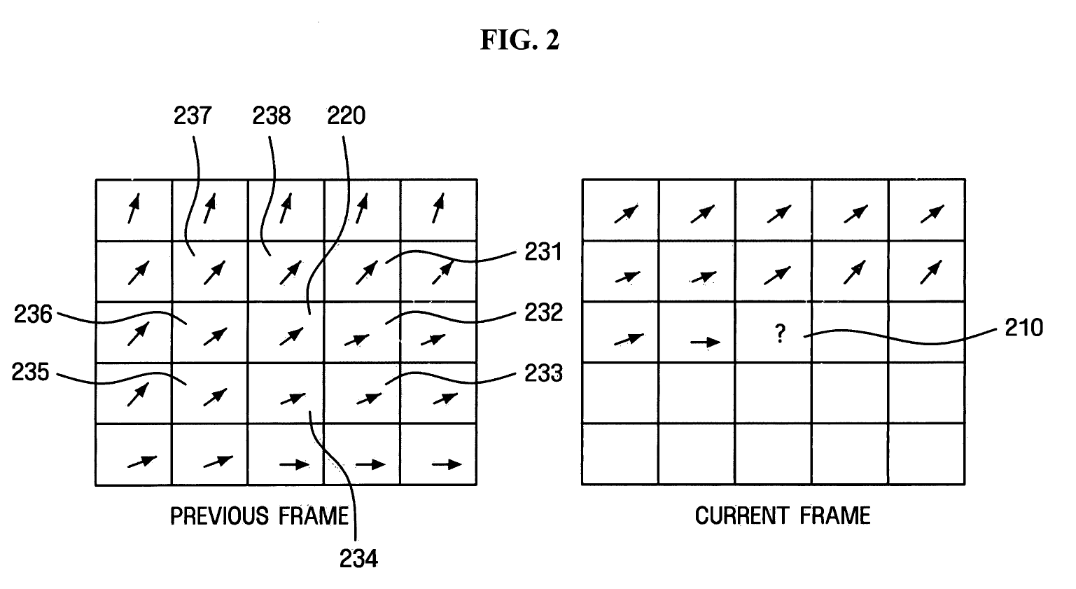

With reference to FIG. 2, in order to estimate a motion vector of a specified block 210 in the current frame, an optimum candidate motion vector of the block 210 of the current frame is estimated considering motion vectors of a block 220 of the previous frame which is in the same position as the block 210 of the current frame, and eight neighboring blocks 231, 232, 233, 234, 235, 236, 237, and 238. In this case, the current frame can be understood as a frame that is added when the frame rate of the appliance outputting the image frame source is higher than the frame rate of the image frame source.

A motion vector having the minimum sum of absolute differences (SAD) among motion vectors of a block of the previous frame that is in the same position as a corresponding block of the current frame of which the motion vector is to be estimated and eight neighboring blocks is estimated as the optimum candidate motion vector, as indicated by Equation (1).

$$\begin{matrix}{\vec{C}}_{opt} = {min}_{d ∈ CS} \{ SAD ( \vec{d} , \vec{x} , n ) \} \\ = {min}_{d ∈ CS} \{ {\sum }_{\vec{x} ∈ B ( \vec{X} )}^{} \vert F ( \vec{X} , n ) - F ( \vec{X} - \vec{d} , n - 1 ) \}\end{matrix} \qquad ( 1 )$$

In Equation (1), B(\vec{X}) is a block of a current frame of which the motion vector is to be estimated, \vec{d} is a candidate motion vector, CS is a set of whole candidate motion vectors, F is a luminance value of a Y signal, \vec{X} and \vec{x} are coordinate values in the block of a current frame of which the motion vector is to be estimated, and n is a frame number. \vec{C}ₒₚₜ is an optimum candidate motion vector.

The motion vector estimation unit 110 estimates the optimum candidate motion vector as described above, and then estimates the final motion vector by correcting the estimated optimum candidate motion vector according to the similarity between motion according to the estimated optimum candidate motion vector and motion of the previous frame.

The final motion vector may be estimated through diverse methods , for example, but not limited to, bypassing, updating through a limited region search, updating through a full region search, and others. These methods for estimating the final motion vector may be determined according to correlations among respective SAD values obtained with respect to the methods. In the exemplary embodiment of the present invention, bypassing is called a first method, updating through the limited search region is called a second method, and updating through the full search regions is called a third method. The first method is applied to a case where motion of a specified block of the current frame is almost similar to that of the previous frame. In the first method, the optimum candidate motion vector estimated from the previous frame is used as the final motion vector. In the second method, the optimum candidate motion vector for the limited search region is updated. In the third method, the final motion vector is updated by performing a search with respect to the full search region, irrespective of the optimum candidate motion vector.

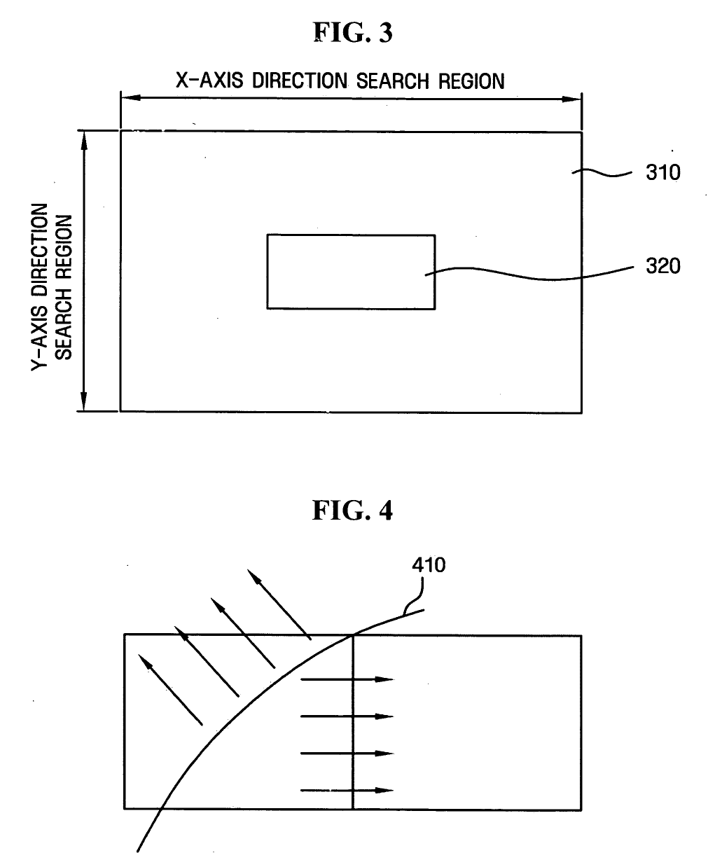

In the methods for estimating the final motion vector, SAD values for the respective methods are obtained, and then the maximum value and the minimum value among the obtained SAD values are obtained. If an absolute value of a difference between the maximum value and the minimum value exceeds a threshold value, it is judged that the correlation between the current frame and the previous frame is quite low, and thus the third method is used. If the absolute value is smaller than the threshold value and the maximum value is the same as the minimum value, the first method is used; otherwise, SAD values for the first method and the second method are compared with each other, and the second method is used only when the SAD value for the second method is sufficiently smaller than that for the first method. In addition, in a method of estimating the final motion vector, a limited search region 320 is smaller than a full search region 310 in a specified frame, as shown in FIG. 3, which illustrates an example of the full search region 320 in X-axis and Y-axis directions.

The motion vector post-processing unit 120 performs a smoothing of the estimated final motion vector on the basis of the characteristic that the final motion vector estimated by the above-described motion estimation unit 110 has a strong spatial correlation.

This motion vector post-processing unit 120 divides directions of motion vectors in a specified frame into the predetermined number of representative directions, and obtains representative motion vectors of the specified frame. In the exemplary embodiment of the present invention, the motion vector post-processing unit 120 divides the directions of the motion vectors into nine representative directions. However, this is exemplary, and thus the number of representative directions may be increased or decreased.

The motion vector post-processing unit 120 quantizes the direction of the motion vectors in the specified frame, obtains the numbers of blocks belonging to the representative directions as described above, and then determines the representative direction having the largest number of blocks as the representative motion direction. In addition, the motion vector post-processing unit 120 extracts the final motion vector post-processed through weighted averages of the SAD values of the respective blocks by using only the blocks that belong to the determined representative motion direction. That is, the motion vector post-processing unit 120 performs the smoothing of the final motion vector so that the respective blocks in the specified frame have successive motion vector directions, using the characteristic that the respective blocks have strong spatial correlation with neighboring blocks.

The motion error concealment unit 130 conceals an error due to discontinuity among motion vectors on a boundary surface 410 of an object, which may cause a severe picture-quality deterioration, as illustrated in FIG. 4, if a strong panning, such as movement of a camera against a still background or a strong motion in a horizontal direction, occurs after the final motion vector is post-processed. In the exemplary embodiment of the present invention, the discontinuity between blocks having motion vectors in an opposite direction to the X-axis direction components of the motion vectors is detected.

The motion error concealment unit 130 detects the discontinuity through the difference between the X-axis direction component of a motion vector of a specified block in a specified frame and the X-axis direction component of a motion vector of a neighboring block. In this case, the difference in direction between the X-axis direction components can be obtained through an absolute value of the difference between a motion vector of a center block and a motion vector of a neighboring block as Equation (2).
MV_{Diff}=|MV_{cent}−MV_{neigh}| (2)

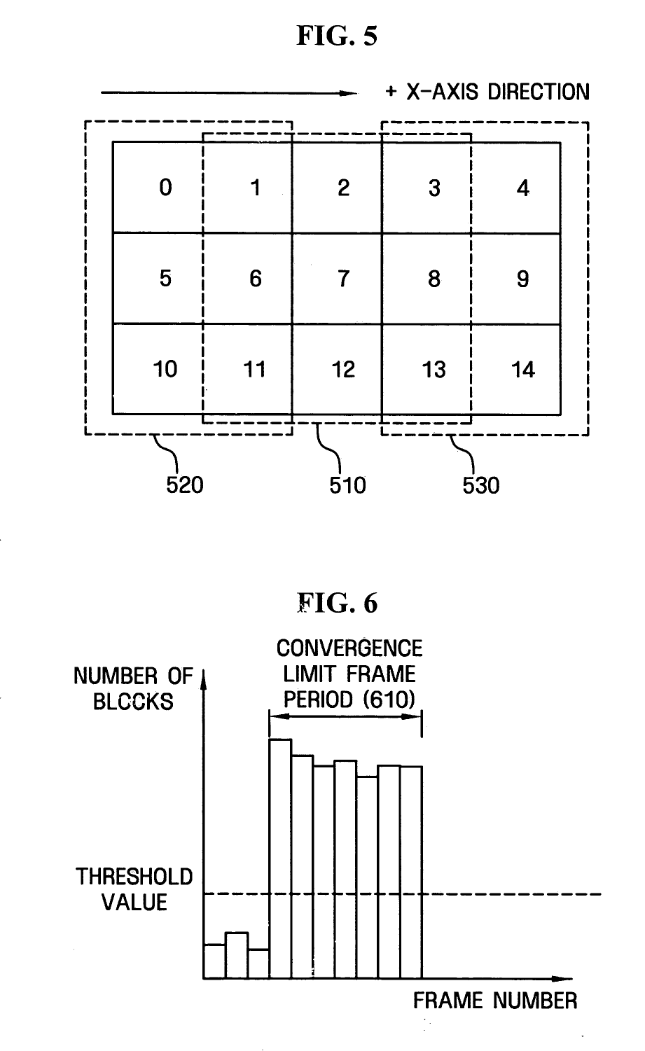

In Equation (2), MV_{Diff} is an absolute value, MV_{cent} is a motion vector of a center block of the current frame, and MV_{neigh} is a motion vector of a block neighboring the center block of the current frame. That is, as illustrated in FIG. 5, if the number of blocks is more than the predetermined number of blocks in which the absolute value of the motion vector difference among a center block of the current frame 510, a block group 520 that exists in a negative X-axis direction, and a block group 530 that exists in a positive X-axis direction, in 5*3 blocks exceeds a threshold value, it is judged that the motion vectors are discontinuous on the boundary surface 410 as illustrated in FIG. 4, and the error is concealed using a non-linear filtering as expressed in Equation (3).
I_{finalMC}=Med{I(\vec{X},n),I(\vec{X}, n−1),I_{MC}(\vec{X}, n−α)}0<α<1 (3)

In Equation (3), I(\vec{X}, n) is an original signal value of the current frame, I(\vec{X},n−1) is an original signal value of the previous frame, and I_{MC}(\vec{X}, n−α) is a compensated data value using the final motion vector of the current block.

The frame repetition unit 140 determines whether to repeatedly use the original signal of the previous frame instead of a motion interpolation when an accuracy of motion estimation is degraded, because the motion estimation is limited by the maximum motion information for estimating motion according to the size of a search region and may appear in diverse forms with respect to diverse motions. In other words, if motion escapes from a search region, the temporal-spatial correlation between the current frame and the previous frame is greatly degraded, and thus the repeated use of the original signal of the previous frame can improve a confidence score of the motion estimation in comparison to the motion interpolation.

In the exemplary embodiment of the present invention, the frame repetition unit 140 adaptively determines whether to repeatedly use the previous frame in accordance with the number of blocks used in the full search.

If the confidence score of the motion estimation is degraded in the full search region, the number of blocks used in the full search is relatively increased. The frame repetition unit 140 judges that the motion vectors do not converge if the number of blocks used in the full search is not considerably decreased, and repeatedly uses the original signal of the previous frame.

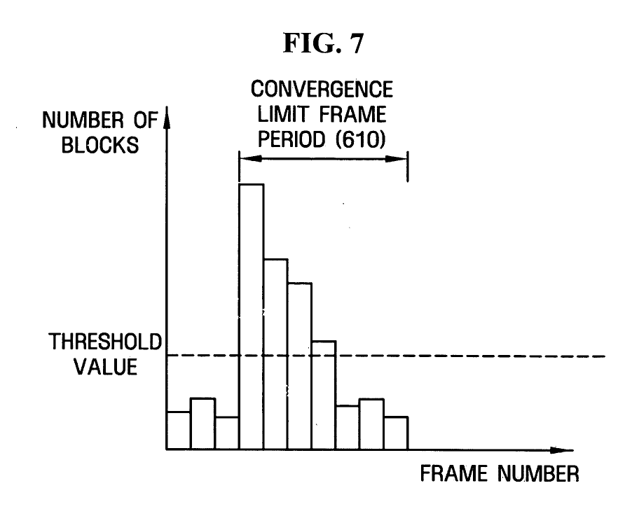

For example, as illustrated in FIG. 6, if the number of blocks used in the full search in a convergence limit frame period 610 is decreased below the threshold value, the motion estimation is used. By contrast, if the number of blocks used in the full search in a convergence limit frame period 610 exceeds the threshold value, as shown in FIG. 7, it is judged that the temporal-spatial correlation between the current frame and the previous frame is greatly degraded, and thus the original signal of the previous frame is repeatedly used.

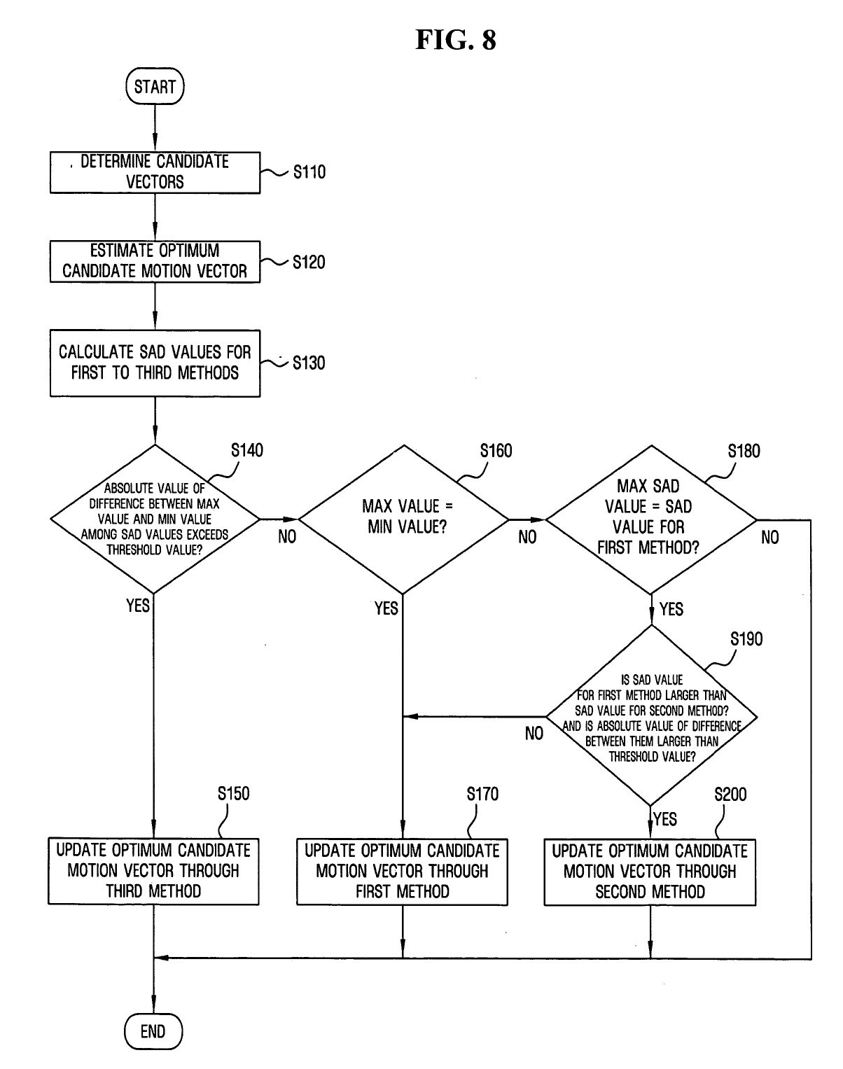

FIG. 8 is a flowchart illustrating a method of estimating a final motion vector according to an embodiment of the present invention.

According to the method of estimating the final motion vector according to an exemplary embodiment of the present invention as illustrated in FIG. 8, the motion vector estimation unit 110 sets a motion vector of a block of the previous frame, which is in the same position as a block of the current frame, and motion vectors of neighboring blocks, as candidate vectors S110.

The motion vector estimation unit 110 estimates the candidate vector having the minimum SAD value, as expressed in Equation (1), among the estimated candidate vectors, as the optimum candidate motion vector S120. Then, the motion vector estimation unit 110 determines whether to update the estimated optimum candidate motion vector. In other words, the motion vector estimation unit 110 determines whether to update the optimum candidate motion vector by using the first to third methods as described above.

At this time, the motion vector estimation unit 110 calculates SAD values for the respective methods S130.

In addition, the motion vector estimation unit 110 judges whether an absolute value of the difference between the maximum value and the minimum value among the calculated SAD values for the respective methods exceeds the threshold value S140.

If it is judged that the absolute value obtained in step S140 exceeds the threshold value and the minimum value is the SAD value for the third method, the motion vector estimation unit 110 updates the optimum candidate motion vector through the third method S150.

If it is judged that the absolute value obtained in step S140 does not exceed the threshold value, the motion vector estimation unit 110 judges whether the minimum SAD value and the maximum SAD value are the same S160, and if it is judged that the minimum SAD value is the same as the maximum SAD value, the motion vector estimation unit uses the optimum candidate motion vector as the final motion vector by using the first method S170.

If it is judged that the minimum SAD value is different from the maximum SAD value, the motion vector estimation unit judges whether the maximum SAD value is the SAD value for the first method S180, and if the maximum SAD value is the SAD value for the first method, it judges whether the absolute value of the difference between the SAD values for the first and second methods is larger than the threshold value and whether the SAD value for the first method is larger than the SAD value for the second method. If the absolute value of the difference between the SAD values for the first and second methods is larger than the threshold value and the SAD value for the first method is larger than the SAD value for the second method S190, the motion vector estimation unit uses the second method S200; otherwise, the motion vector estimation unit updates the optimum candidate motion vector using the first method, and uses the updated optimum candidate motion vector as the final motion vector. As described above, through the steps S150, S170, and S200 of FIG. 8, the updated optimum candidate motion vector is used as the final motion vector.

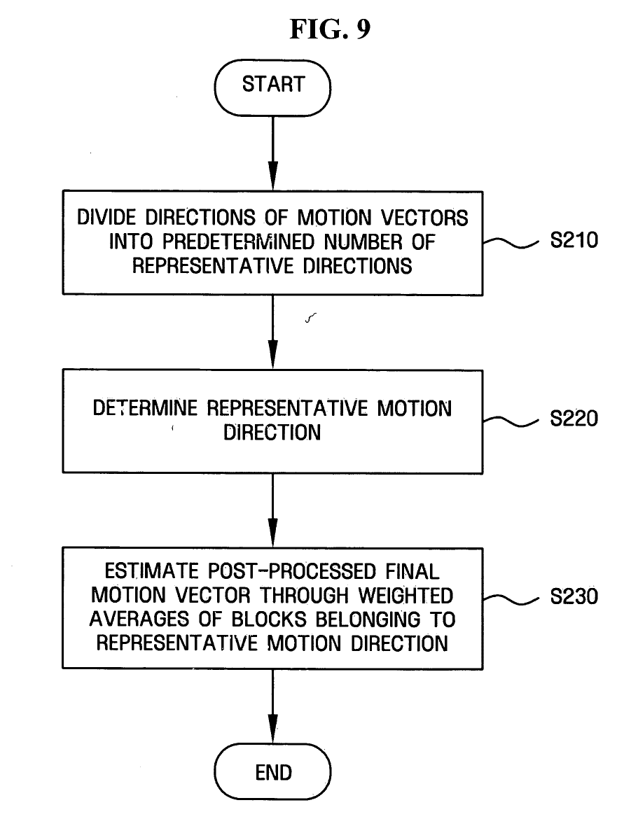

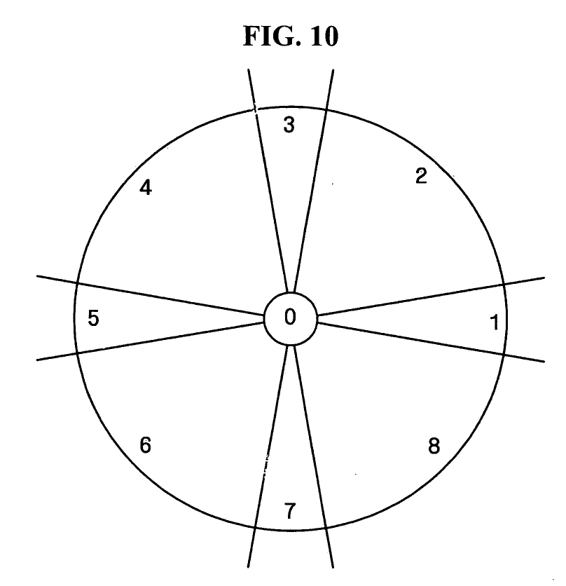

FIG. 9 is a flowchart illustrating a method of post-processing a motion vector according to an exemplary embodiment of the present invention.

According to the method of post-processing the motion vector according to an exemplary embodiment of the present invention as illustrated in FIG. 9, the motion vector post-processing unit 120 divides the directions of motion vectors in a specified frame into the predetermined number of representative directions S210. In the exemplary embodiment of the present invention, the motion vector post-processing unit 120 divides the directions of the motion vectors into nine representative directions, and the center region has the motion vector of “0” as illustrated in FIG. 10.

The motion vector post-processing unit 120 determines the representative direction having the largest number of blocks among the representative directions as the representative motion direction S220.

The motion vector post-processing unit 120 extracts the final motion vector post-processed through weighted averages of the SAD values of the respective blocks by using only the blocks that belong to the motion direction S230.

That is, the motion vector post-processing unit 120 performs the smoothing of the final motion vector so that the respective blocks in the specified frame have successive motion vector directions, using the characteristic that the respective blocks have strong spatial correlation with neighboring blocks.

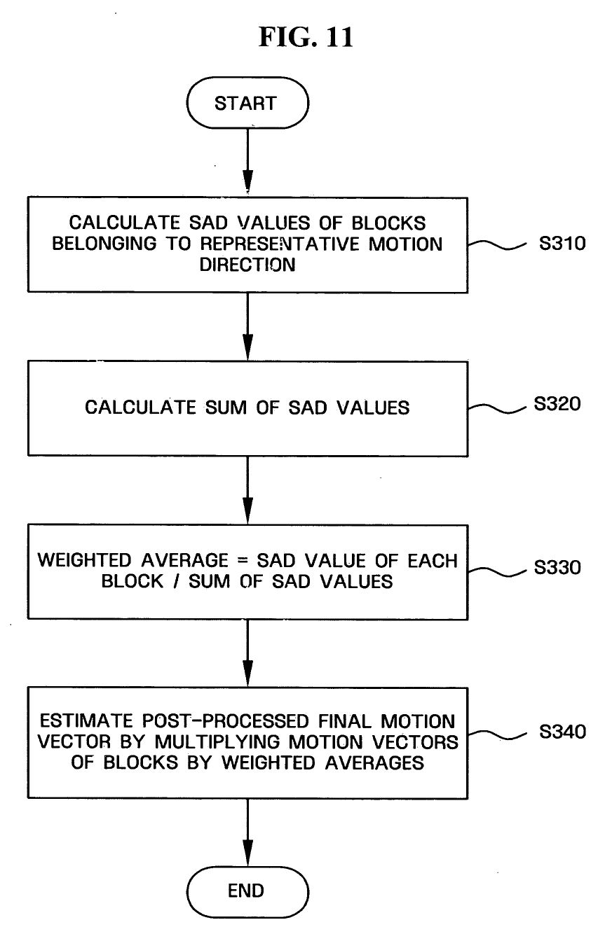

FIG. 11 is a flowchart illustrating a method of calculating weighted averages according to an exemplary embodiment of the present invention.

According to the method of calculating weighted averages according to an exemplary embodiment of the present invention as illustrated in FIG. 11, the motion vector post-processing unit 130 calculates SAD values of the respective blocks that belong to the representative motion direction in a specified frame S310. In the exemplary embodiment of the present invention, it is exemplified that 5*3 blocks are used, and thus the SAD values are obtained for 15 blocks.

The motion vector post-processing unit 120 obtains the sum of the SAD values.

The motion vector post-processing unit 120 obtains the weighted averages by dividing the SAD values of the respective blocks that belong to the representative motion direction by the sum of the SAD values S330. The motion error concealment unit 130 obtains weighted averages of the respective blocks by dividing the SAD values of the respective blocks that belong to the representative motion direction by the sum of the SAD values, respectively.

The motion vector post-processing unit 130 extracts the post-processed final motion vector by multiplying the motion vectors of the respective blocks, which belong to the representative motion direction, by the weighted averages S340.

In the exemplary embodiments of the present invention, the term “unit,” as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, for example, but not limited to, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

As described above, according to the apparatus and method for frame interpolation based on motion estimation according to the present invention, the frame rate of an image frame source can be converted through motion estimation of an image frame when the image frame source having diverse frame rates is output to an appliance having a fixed frame rate, and thus a high-precision image frame can be output.

The exemplary embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. An apparatus for frame interpolation based on motion estimation, comprising:
a motion vector estimation unit which estimates a final motion vector of a block in a specified frame;
a motion vector post-processing unit which smoothes the estimated final motion vector; and
a motion error concealment unit which conceals an error due to discontinuity among blocks having the smoothed final motion vector.

2. The apparatus of claim 1, wherein the motion vector estimation unit determines motion vectors of a block of a previous frame, which has a same position as a block of a current frame of which the motion vector is to be estimated, and neighboring blocks of the previous frame as candidate vectors;
estimates a candidate vector having a minimum sum of absolute difference (SAD) value among the candidate vectors as an optimum candidate motion vector; and
estimates the final motion vector using at least one of a first method that uses the estimated optimum candidate motion vector as the final motion vector, a second method that updates the estimated optimum candidate motion vector with respect to a limited search region, and a third method that updates the estimated optimum candidate motion vector with respect to a full search region.

3. The apparatus of claim 2, wherein the motion vector estimation unit obtains SAD values for the first to third methods, and estimates the final motion vector through the third method if an absolute value of a difference between a maximum value and a minimum value among the SAD values for the first to third methods exceeds a specified threshold value.

4. The apparatus of claim 2, wherein the motion vector estimation unit obtains SAD values for the first to third methods, and estimates the final motion vector through the first method if an absolute value of a difference between a maximum value and a minimum value among the SAD values for the first to third methods is below a specified threshold value and the maximum value and the minimum value are the same.

5. The apparatus of claim 2, wherein the motion vector estimation unit obtains SAD values for the first to third methods, and estimates the final motion vector through the second method if an absolute value of a difference between a maximum value and a minimum value among the SAD values for the first to third methods is below a specified threshold value, the SAD value for the first method is the maximum value, and the SAD value for the second method is smaller than the SAD value for the first method by the specified threshold value or more.

6. The apparatus of claim 2, further comprising a frame repetition unit repeatedly using the previous frame if a number of blocks used in the first to third methods for a specified frame period exceeds a specified threshold value.

7. The apparatus of claim 1, wherein the motion vector post-processing unit divides directions of motion vectors in blocks of the frame into a number of representative directions;
determines a representative direction to which a largest number of motion vectors belong as a representative motion direction;
obtains weighted averages of the blocks by dividing sum of absolute difference (SAD) values of the respective blocks that belong to the determined representative motion direction by a sum of the SAD values of the blocks that belong to the determined representative motion direction; and
estimates a post-processed final motion vector by applying the obtained weighted averages of the respective blocks to the final motion vector of the corresponding block.

8. The apparatus of claim 1, wherein the motion error concealment unit judges that a discontinuity has occurred if an absolute value of a difference between a motion vector of a block corresponding to a boundary surface of an object that belongs to the frame and a motion vector of a block neighboring the boundary surface exceeds a specified threshold value, and if the discontinuity has occurred, reduces picture-quality deterioration through non-linear filtering.

9. A method for frame interpolation based on motion estimation, comprising:
estimating a final motion vector of a block in a specified frame;
smoothing the estimated final motion vector; and
concealing an error due to discontinuity among blocks having the smoothed final motion vector.

10. The method of claim 9, wherein the estimating the final motion vector comprises:
determining motion vectors of a block of a previous frame, which has the same position as a block of a current frame of which the motion vector is to be estimated, and neighboring blocks of the previous frame, as candidate vectors;
estimating a candidate vector having a minimum sum of absolute difference (SAD) value among the candidate vectors, as an optimum candidate motion vector; and
estimating the final motion vector using at least one of a first method that uses the estimated optimum candidate motion vector as the final motion vector, a second method that updates the estimated optimum candidate motion vector with respect to a limited search region, and a third method that updates the estimated optimum candidate motion vector with respect to a full search region.

11. The method of claim 10, wherein the estimating the final motion vector comprises obtaining SAD values for the first to third methods, and estimating the final motion vector through the third method if an absolute value of a difference between aa maximum value and a minimum value among the SAD values for the first to third methods exceeds a specified threshold value.

12. The method of claim 10, wherein the estimating the final motion vector comprises obtaining SAD values for the first to third methods, and estimating the final motion vector through the first method if an absolute value of a difference between a maximum value and a minimum value among the SAD values for the first to third methods is below a specified threshold value and the maximum value and the minimum value are the same.

13. The method of claim 10, wherein the estimating the final motion vector comprises obtaining SAD values for the first to third methods, and estimating the final motion vector through the second method if an absolute value of a difference between a maximum value and a minimum value among the SAD values for the first to third methods is below a specified threshold value, the SAD value for the first method is the maximum value, and the SAD value for the second method is smaller than the SAD value for the first method by the specified threshold value or more.

14. The method of claim 10, further comprising repeatedly using the previous frame if the number of blocks used in the first to third methods for a specified frame period exceeds a specified threshold value.

15. The method of claim 9, wherein the smoothing the estimated final motion vector comprises:
dividing directions of motion vectors in blocks of the frame into a number of representative directions, and determining the representative direction, to which a largest number of motion vectors belong, as a representative motion direction;
obtaining weighted averages of the blocks by dividing sum of absolute difference (SAD) values of the respective blocks that belong to the determined representative motion direction by a sum of the SAD values of the blocks that belong to the determined representative motion direction; and
estimating a post-processed final motion vector by applying the obtained weighted averages of the respective blocks to the final motion vector of the corresponding block.

16. The method of claim 9, wherein the concealing the motion error comprises:
judging that a discontinuity has occurred if an absolute value of a difference between a motion vector of a block corresponding to a boundary surface of an object that belongs to the frame and a motion vector of a block neighboring the boundary surface exceeds a specified threshold value; and
if the discontinuity has occurred, reducing picture-quality deterioration through non-linear filtering.

17. A system for frame interpolation based on motion estimation, comprising:
a motion vector estimation unit which estimates a final motion vector of a block in a specified frame using at least one of a first method that uses an estimated optimum candidate motion vector as a final motion vector, a second method that updates an estimated optimum candidate motion vector with respect to a limited search region, and a third method that updates an estimated optimum candidate motion vector with respect to a full search region;
a motion vector post-processing unit which divides directions of motion vectors in blocks of the frame into a number of representative directions, determines a representative motion direction, obtains weighted averages of the blocks and estimates a post-processed final motion vector by applying the obtained weighted averages of the respective blocks to the final motion vector of the corresponding block; and
a motion error concealment unit which conceals an error due to discontinuity among blocks having the smoothed final motion vector through non-linear filtering.
